(19) United States
(12) Patent Application Publication
(10) Pub. No.: US 2012/0236136 A1
(43) Pub. Date: Sep. 20, 2012

(54) INTERIOR REARVIEW MIRROR WITH ALCOHOL DETECTION

(75) Inventor: Ian Boddy, Ada, MI (US)

(73) Assignee: MAGNA MIRRORS OF AMERICA, INC., Holland, MI (US)

(21) Appl. No.: 13/419,459

(22) Filed: Mar. 14, 2012

Related U.S. Application Data
(60) Provisional application No. 61/452,685, filed on Mar. 15, 2011.

(51) Int. Cl. H04N 7/18; G08B 23/00

(52) U.S. Cl. 348/78; 340/576; 348/E07.085

(57) ABSTRACT

An alcohol sensing system for a vehicle includes an alcohol sensing device disposed at or near an interior rearview mirror assembly of the vehicle. The alcohol sensing device is operable to detect a level of alcohol in the breath of a driver of the vehicle. An alert element is operable to provide an alert when the detected alcohol level is above a threshold level. The alcohol sensing device may be incorporated in the interior rearview mirror assembly. The alert element may include a display element operable to display visible information at the interior rearview mirror assembly that is viewable by the driver of the vehicle and that is indicative of the detected alcohol level. The display element may be operable to display different ranges of alcohol levels and to indicate in which range the detected alcohol level falls.

### CROSS REFERENCE TO RELATED APPLICATION

The present application claims the priority benefit of U.S. provisional application Ser. No, 61/452,685, filed Mar. 15, 2011, which is hereby incorporated herein by reference in its entirety.

### FIELD OF THE INVENTION

The present invention relates to breathalyzers for detecting an alcohol content or level of a person's blood after they have consumed one or more alcoholic beverages.

### BACKGROUND OF THE INVENTION

Many accidents occur each year as a result of a vehicle driver driving under the influence of alcohol. Some states have already legislated a shutoff device that precludes starting of a vehicle if the driver fails a breathalyzer test via a testing device. Insurances are even offering a reduction in insurance rates for vehicles with such devices.

### SUMMARY OF THE INVENTION

The present invention provides an interior rearview mirror assembly for a vehicle where the interior rearview mirror assembly includes an alcohol sensing device that senses the alcohol content of a user's breath to determine the user's blood alcohol content.

According to an aspect of the present invention, an alcohol detecting or sensing device is operable to sense or detect alcohol on a person's breath and provide a readout or output indicative of the person's blood alcohol content. The alcohol detecting device is disposed at the interior rearview mirror assembly or at a windshield electronics module so as to be located in close proximity to the driver's breath for enhanced breath alcohol detection.

Optionally, the mirror assembly and/or windshield electronics module may include a display device for displaying an information display indicative of the detected breath alcohol level. For example, the display may provide a warning signal or the like, such as via a display on demand display or the like at the mirror reflective element, so that the driver is made aware of his or her breath test results.

These and other objects, advantages, purposes and features of the present invention will become apparent upon review of the following specification in conjunction with the drawings.

### BRIEF DESCRIPTION OF THE DRAWINGS

FIG. 1 is a plan view of a portion of a vehicle having an interior rearview mirror assembly in accordance with the present invention; and

FIG. 2 is a plan view and partial sectional view of the interior rearview mirror assembly of FIG. 1.

### DESCRIPTION OF THE PREFERRED EMBODIMENTS

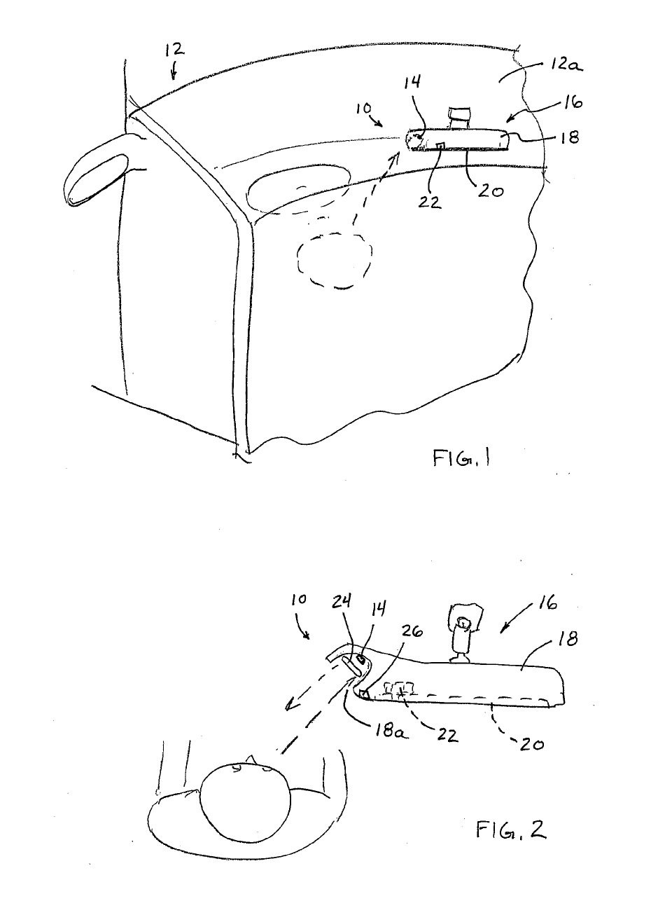

Referring now to the drawings and the illustrative embodiments depicted therein, an alcohol sensing system 10 for a vehicle 12 includes an alcohol sensing device 14 at an interior rearview mirror assembly 16 (FIGS. 1 and 2). Interior rearview mirror assembly 16 includes a casing 18 and a reflective element 20 and is mounted at an interior portion of the vehicle, such as at an interior surface of a vehicle windshield 12a. Alcohol sensing device 14 is operable to detect or determine an alcohol level of the driver's breath. The alcohol sensing system 10 may also include a display element or device 22 that is operable to display an alert signal or information display indicative of the driver's blood alcohol level in response to the alcohol sensing device 14, as discussed below.

As shown in FIGS. 1 and 2, the locating of an alcohol sensing device at or near the interior rearview mirror assembly of the vehicle provides an alcohol sensing device that is proximate to the driver and generally in the path of the driver's breath. The alcohol sensing device may utilize aspects of known breathalyzers or alcohol sensing devices, such that a detailed discussion as to how the alcohol sensing device operates need not be included herein. Briefly, the alcohol sensing device may include or be associated with a control or processor for processing the air at the sensing device and determining the alcohol content in the sampled air and further determining or estimating a person's blood alcohol content based on the processing of the sampled air, such as in a manner similar to known breathalyzers and the like.

The alcohol sensing device 14 is preferably located at the driver side of the mirror casing 18, and may be directed generally toward the driver's head to enhance sensing of the driver's breath. Optionally, the alcohol sensing device 14 may be disposed at an entry port 18a (FIG. 2) at the driver's side of the casing 18, and the entry port may be directed or aimed toward a typical driver's mouth location. Optionally, and as shown in FIG. 2, the mirror assembly may include a fan or air circulation device 24 at the entry port 18a, whereby the fan may be operable to draw air into the entry port (from the direction toward the driver's mouth) and cause the air to pass over or through the alcohol sensing device 14. The fan may outlet the drawn in air back toward the driver to cause a loop or circular flow of air at the driver (whereby the port has an inlet side or air drawing side and an outlet side or portion or air discharge side or portion). Optionally, the fan may otherwise outlet the drawn in air at the rear or side portion of the casing or elsewhere at the mirror assembly, while remaining within the spirit and scope of the present invention.

Optionally, and desirably, the mirror assembly includes display element 22, which is operable to provide a signal or display that is indicative of the operation of the alcohol sensing device 14. For example, the display element may provide a visible display that alerts the driver as to his or her blood alcohol level as determined by the alcohol sensing device and/or processor. The display element may provide a warning or alert when the detected alcohol content is above a threshold level, and the mirror assembly may provide both a visible alert (such as via the display element) and an audible alert (such as via a speaker or the like at the mirror assembly or elsewhere in the vehicle).

The display element may comprise any suitable display element or device that provides a visible display, such as a textual or alphanumeric display or iconsitic display or the like, at the mirror assembly (or optionally elsewhere at the vehicle and viewable by the driver of the vehicle). Thus, the warning or alert signal or signals may be integrated or incorporated in the rearview mirror, where they are readily viewable by the driver (or other occupants) of the vehicle. For example, the display device may provide a display on demand display device that is located behind the mirror reflective element 20 so that the display information is viewable through the reflective element when the display element or device is activated or energized, but is substantially not viewable when the display element is deactivated. Optionally, the display device or element may provide a varying display to display or indicate different detected levels, such as a bar graph and/or color-coded indication (such as red, yellow, green indicators) or an intensity variation or the like, that indicate to the driver of the vehicle the range at which the detected alcohol content falls. Optionally, the audible alert may be provided (and the intensity of the audible alert may be varied or different voice messages may be provided) at one or more of the threshold levels to provide further indication to the driver (or other occupants) of the vehicle that the detected alcohol level is above a threshold level. Thus, the visible and audible warnings or alerts or signals may be intensity-based and/or content-based/message-based depending on the level of alcohol detected by the alcohol sensing device.

Optionally, the alcohol sensing system 10 may be operable to communicate or interact with the vehicle ignition (or other vehicle control) to shut off or lock the vehicle ignition to prevent a driver from driving the vehicle if the detected alcohol content of the driver's breath exceeds a threshold level. For example, the alcohol sensing system may communicate with the starter control or other control module of the vehicle, such as by utilizing aspects of the starter systems described in U.S. Pat. No. 7,650,864, which is hereby incorporated herein by reference in its entirety. The communication with the vehicle ignition or control may be provided via a wireless communication or other communication link, such as a vehicle bus or the like.

Optionally, the alcohol sensing system 10 may be associated with an imaging sensor or camera or imaging system 26 that includes an imaging sensor having a field of view directed toward the driver's head. The imaging sensor may capture images of the driver's head and an image processor may process the captured images to detect the driver's eyes and/or to detect movement of the driver's head or the like. If the imaging system detects that the driver's eyes are dilated or that the driver appears to be moving or otherwise acting in a way that is indicative of the driver's blood alcohol content to be above a threshold level, the alcohol sensing system may provide the display and/or audible alert and/or may lock or deactivate the vehicle ignition in response to such detection. The signal from the image processor may be analyzed or processed by the alcohol sensing system to confirm a detected threshold level of alcohol content that is detected by the alcohol sensing device.

The imaging sensor may comprise any suitable type of image sensor, such as an imaging array sensor having a plurality of pixels or photo sensors, such as a CCD sensor or a CMOS image sensor or the like, and/or may utilize aspects of the image sensors and/or vision systems described in U.S. Pat. Nos. 5,550,677; 5,670,935; 5,796,094; 6,396,397; 6,097,023; 7,339,149; 7,965,336; and/or 7,480,149, and/or PCT Application No. PCT/US2006/041709, filed Oct. 27, 2006 and published May 10, 2007 as International Publication No. WO 07/053,404, which are all hereby incorporated herein by reference in their entireties. Optionally, the image sensor or sensors may be operable utilizing the principles of such other vehicular vision or detection systems, such as a vehicle headlamp control system, such as the types disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 7,480,149; 6,353,392; 6,313,454; and/or 6,320,176, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,038,577; 5,929,786; 5,786,772; 7,463,138; 7,881,496; and/or 7,720,580, and/or U.S. provisional applications, Ser. No, 60/628,709, filed Nov. 17, 2004; Ser. No, 60/614,644, filed Sep. 30, 2004; Ser. No. 60/618,686, filed Oct. 14, 2004; Ser. No. 60/638,687, filed Dec. 23, 2004, which are all hereby incorporated herein by reference in their entireties, a video device for internal cabin surveillance and/or video telephone function, such as disclosed in U.S. Pat. Nos. 7,370,983; 5,760,962; 5,877,897; and/or 6,690,268; and/or PCT Application No. PCT/US03/40611, filed Dec. 19, 2003 and published Ju1.15, 2004 as International Publication No, WO 04/058540, and/or U.S. patent application. Ser. No. 10/538,724, filed Jun. 13, 2005 and published Mar. 9, 2006 as U.S. Publication No, US-2006-0050018-A1, and/or U.S. provisional applications, Ser. No. 60/630,061, filed Nov. 22, 2004; and Ser. No. 60/667,048, filed Mar. 31, 2005, which are all hereby incorporated herein by reference in their entireties, a traffic sign recognition system, a system for determining a distance to a leading or trailing vehicle or object, such as a system utilizing the principles disclosed in U.S. Pat. Nos. 7,123,168 and/or 6,396,397, which are hereby incorporated herein by reference in their entireties, and/or the like.

Optionally, the display element or device of the alcohol sensing system may comprise one or more displays, such as the types disclosed in U.S. Pat. Nos. 5,530,240 and/or 6,329,925, which are hereby incorporated herein by reference, and/or display-on-demand or transflective type displays, such as the types disclosed in U.S. Pat. Nos. 7,274,501; 7,255,451; 7,195,381; 7,184,190; 6,690,268; 5,668,663 and/or 5,724,187, and/or in U.S. patent application Ser. No. 10/538,724, filed Jun. 13, 2005 and published Mar. 9, 2006 as U.S. Publication No. US-2006-0050018-A1, and/or U.S. provisional applications, Ser. No. 60/630,061, filed Nov. 22, 2004; Ser. No. 60/667,048, filed Mar. 31, 2005; Ser. No. 60/629,926, filed Nov. 22, 2004; Ser. No. 60/531,838, filed Dec. 23, 2003; Ser. No. 60/553,842, filed Mar. 17, 2004; and Ser. No. 60/563,342, filed Apr. 19, 2004, which are all hereby incorporated herein by reference in their entireties, or may include or incorporate video displays or the like, such as the types described in U.S. Pat. Nos. 7,370,983; 7,777,611 and/or 7,370,983, and/or U.S. patent application Ser. No, 10/538,724, filed Jun. 13, 2005 published Mar. 9, 2006 as U.S. Publication No. US-2006-0050018-A1, which are hereby incorporated herein by reference in their entireties, or may comprise or incorporate level indicating displays, such as displays of the types described in U.S. Pat. No. 7,492,281 and U.S. provisional applications, Ser. No. 60/696,953, filed Jul. 6, 2005, and Ser. No. 60/784,570, filed Mar. 22, 2006, which are hereby incorporated herein by reference in their entireties), or other types of indicating means, such as by utilizing aspects of the displays or indicators described in U.S. Pat. Nos. 7,626,749 and/or 6,598,982, and/or U.S. patent application Ser. No. 11/226,628, filed Sep. 14, 2005 and published Mar. 23, 2006 as U.S. Patent Publication No. 20060061008, which are hereby incorporated herein by reference in their entireties.

Optionally, and desirably, the mirror reflective element may comprise a transflective display on demand reflective element that is partially transmissive and partially reflective, so that the light emanating from the video display device or module may be transmitted through the reflective element when the display device or illumination source is activated, but substantially non-visible or viewable when the video display device or illumination source is deactivated. For example, the reflective element of the rearview mirror assembly may comprise an electro-optic or electrochromic reflective element or cell, such as an electrochromic mirror assembly and electrochromic reflective element utilizing principles disclosed in commonly assigned U.S. Pat. Nos. 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407; 4,712,879; 7,195,381; and/or 7,255,451, and/or U.S. patent application Ser. No. 11/226,628, filed Sep. 14, 2005, published Mar. 23, 2006 as U.S. Patent Publication No. 20060061008, and/or U.S. provisional applications, Ser. No. 60/695,149, filed Jun. 29, 2005; Ser. No. 60/690,400, filed Jun. 14, 2005; Ser. No. 60/681,250, filed May 16, 2005; and/or Ser. No. 60/692,113, filed Jun. 20, 2005, which are all hereby incorporated herein by reference in their entireties, and/or as disclosed in the following publications: N. R. Lynam, “Electrochromic Automotive Day/Night Mirrors”, SAE Technical Paper Series 870636 (1987); N. R. Lynam, “Smart Windows for Automobiles”, SAE Technical Paper Series 900419 (1990); N. R. Lynam and A. Agrawal, “Automotive Applications of Chromogenic Materials”, Large Area Chromogenics: Materials and Devices for Transmittance Control, C. M. Lampert and C. G. Granquist, EDS., Optical Engineering Press, Wash. (1990), which are hereby incorporated by reference herein in their entireties. The thicknesses and materials of the coatings on the substrates of the electrochromic reflective element, such as on the third surface of the reflective element assembly, may be selected to provide a desired color or tint to the mirror reflective element, such as a blue colored reflector, such as is known in the art and/or such as described in U.S. Pat. Nos. 5,910,854; 6,420,036 and/or 7,274,501, which are all hereby incorporated herein by reference in their entireties.

Optionally, use of an elemental semiconductor mirror, such as a silicon metal mirror, such as disclosed in U.S. Pat. Nos. 7,338,177; 6,286,965; 6,196,688; 5,535,056; 5,751,489; and/or 6,065,840, which are all hereby incorporated herein by reference in their entireties, can be advantageous because such elemental semiconductor mirrors (such as can be formed by depositing a thin film of silicon, such as a thin film of aluminum-doped silicon) can be greater than fifty percent reflecting in the photopic (SAE J964a measured), while being also substantially transmitting of light (up to twenty percent or even more). Such silicon mirrors also have the advantage of being able to be deposited onto a flat glass substrate and to be bent into a curved (such as a convex or aspheric) curvature, which is also advantageous since many passenger-side exterior rearview mirrors are bent or curved.

Optionally, the reflective element may include a perimeter metallic band, such as the types described in U.S. Pat. Nos. 7,274,501; 7,184,190; and/or 7,255,451, and/or U.S. patent application Ser. No, 11/226,628, filed Sep. 14, 2005 and published Mar. 23, 2006 as U.S. Patent Publication No. 20060061008, and/or U.S. provisional applications, Ser. No. 60/692,113, filed Jun. 20, 2005; Ser. No. 60/677,990, filed May 5, 2005; Ser, No. 60/653,787, filed Feb. 17, 2005; Ser, No. 60/642,227, filed Jan. 7, 2005; Ser. No. 60/638,250, filed Dec. 21, 2004; Ser. No. 60/624,091, filed Nov. 1, 2004, and Ser. No. 60/609,642, filed Sep. 14, 2004, which are all hereby incorporated herein by reference. Optionally, the reflective element may include indicia formed at and viewable at the reflective element, such as by utilizing aspects of the reflective elements described in U.S. Pat. No. 7,626,749 and U.S. provisional applications, Ser. No. 60/681,250, filed May 16, 2005; Ser, No. 60/690,400, filed Jun. 14, 2005; Ser. No. 60/695,149, filed Jun. 29, 2005; Ser. No. 60/730,334, filed Oct. 26, 2005; Ser. No, 60/750,199, filed Dec. 14, 2005 Ser. No. 60/774,449, filed Feb. 17, 2006; and Ser. No. 60/783,496, filed Mar. 18, 2006, which are all hereby incorporated herein by reference in their entireties.

Optionally, the reflective element may comprise a single substrate with a reflective coating at its rear surface, without affecting the scope of the present invention. The mirror assembly thus may comprise a prismatic mirror assembly or planar or non-planar mirror or other mirror having a single substrate reflective element, such as a mirror assembly utilizing aspects described in U.S. Pat. Nos. 6,690,268; 5,668,663; 5,724,187; 6,318,870; 6,598,980; 5,327,288; 4,948,242; 4,826,289; 4,436,371; 4,435,042; 7,249,860; and/or 7,289,037, which are all hereby incorporated herein by reference in their entireties. Optionally, the reflective element may comprise a conventional prismatic or flat reflective element or prism, or may comprise a prismatic or flat reflective element of the types described in U.S. Pat. Nos. 7,274,501; 7,420,756; 7,184,190; 7,249,860; 7,255,451; 7,338,177; and/or 7,289,037, which are all hereby incorporated herein by reference in their entireties, without affecting the scope of the present invention.

Although shown and described as being located or disposed at an interior rearview mirror assembly of the vehicle, the alcohol sensing device of the present invention may be otherwise disposed at or near the interior rearview mirror assembly, such as at an accessory module or windshield electronics module at the vehicle windshield, while remaining within the spirit and scope of the present invention. For example, the alcohol sensing device may be disposed at an accessory module or windshield electronics module that utilizes aspects of the types described in U.S. Pat. Nos. 6,877,888; 6,824,281; 6,690,268; 6,672,744; 6,386,742; 6,124,886; and/or 7,289,037, and/or U.S. patent application Ser. No. 10/538,724, filed Dec. 19, 2003 and published Mar. 9, 2006 as U.S. Patent Publication No. 20060050018, which are all hereby incorporated herein by reference in their entireties.

Changes and modifications to the specifically described embodiments may be carried out without departing from the principles of the present invention, which is intended to be limited only by the scope of the appended claims as interpreted according to the principles of patent law.

1. An alcohol sensing system for a vehicle, said alcohol sensing system comprising:
an alcohol sensing device disposed at or near an interior rearview mirror assembly of the vehicle, wherein said alcohol sensing device is operable to detect a level of alcohol in the breath of a driver of the vehicle; and
an alert element operable to provide an alert when the detected alcohol level is above a threshold level.

2. The alcohol sensing system of claim 1, wherein said alcohol sensing device is incorporated into a windshield electronics module disposed at or near said interior rearview mirror assembly.

3. The alcohol sensing system of claim 1, wherein said alcohol sensing device is incorporated into said interior rearview mirror assembly.

4. The alcohol sensing system of claim 3, wherein said alcohol sensing device is disposed at a driver's side of said interior rearview mirror assembly.

5. The alcohol sensing system of claim 4, wherein said alcohol sensing device is located at an entry port formed at said driver's side of said interior rearview mirror assembly, said entry port being directed generally toward a mouth location of a typical driver.

6. The alcohol sensing system of claim 5 further comprising an air circulation device operable to draw air into said entry port and over or through said alcohol sensing device.

7. The alcohol sensing system of claim 1, wherein said alert element comprises a display element operable to display visible information at said interior rearview mirror assembly that is viewable by the driver of the vehicle and that is indicative of the detected alcohol level.

8. The alcohol sensing system of claim 7, wherein said display element is disposed behind a transflective display on demand reflective element of said interior rearview mirror assembly, said display element being viewable through said reflective element when said display element is activated.

9. The alcohol sensing system of claim 7, wherein said display element is operable to display different ranges of alcohol levels and to indicate in which range the detected alcohol level falls.

10. The alcohol sensing system of claim 9, wherein said display element is operable to the different ranges as at least one of (i) different bar graphs, (ii) different colors and (iii) different intensities.

11. The alcohol sensing system of claim 1, wherein said alert element comprises an audible element at said interior rearview mirror assembly, said audible alert being operable to generate an audible alert indicative of the detected alcohol level.

12. The alcohol sensing system of claim 1, wherein said alcohol sensing system is operable to interact with a vehicle ignition to prevent a driver from driving the vehicle if the detected alcohol level exceeds said threshold level.

13. The alcohol sensing system of claim 1, wherein said alcohol sensing system is associated with an imaging sensor having a field of view directed generally toward the driver's head, and wherein said imaging sensor is operable to capture images of the driver's head.

14. The alcohol sensing system of claim 13, comprising an image processor operable to process said captured images to detect at least one of (a) the driver's eyes, (b) dilation of the driver's eyes and (c) movement of the driver's head, and wherein, responsive to said image processing, said alert element is operable to provide said alert when said captured images are indicative of the driver having an alcohol level above said threshold level.

15. The alcohol sensing system of claim 13, wherein said captured images are processed to confirm that a detected alcohol level is above said threshold level.

16. An alcohol sensing system for a vehicle, said alcohol sensing system comprising:
an alcohol sensing device disposed in an interior rearview mirror assembly of the vehicle, and wherein said alcohol sensing device is operable to detect a level of alcohol in the breath of a driver of the vehicle;
an alert element operable to provide an alert when the detected alcohol level is above a threshold level; and
wherein said alert element comprises a display element operable to display visible information at said interior rearview mirror assembly that is viewable by the driver of the vehicle and that is indicative of the detected alcohol level.

17. The alcohol sensing system of claim 16, wherein said alcohol sensing device is located at an entry port formed at said driver's side of said interior rearview mirror assembly, said entry port being directed generally toward a mouth location of a typical driver, and wherein an air circulation device of said interior rearview mirror assembly is operable to draw air into said entry port and over or through said alcohol sensing device.

18. An alcohol sensing system for a vehicle, said alcohol sensing system comprising:
an alcohol sensing device disposed at or near an interior rearview mirror assembly of the vehicle, wherein said alcohol sensing device is operable to detect a level of alcohol in the breath of a driver of the vehicle;
an alert element operable to provide an alert when the detected alcohol level is above a threshold level;
wherein said alert element comprises a display element operable to display visible information at said interior rearview mirror assembly that is viewable by the driver of the vehicle and that is indicative of the detected alcohol level;
wherein said display element is disposed behind a transflective display on demand reflective element of said interior rearview mirror assembly, said display element being viewable through said reflective element when said display element is activated; and
wherein said display element is operable to display different ranges of alcohol levels and to indicate in which range the detected alcohol level falls.

19. The alcohol sensing system of claim 18, wherein said display element is operable to the different ranges as at least one of (i) different bar graphs, (ii) different colors and (iii) different intensities.

20. The alcohol sensing system of claim 18, wherein said alcohol sensing system is associated with an imaging sensor having a field of view directed generally toward the driver's head, and wherein said imaging sensor is operable to capture images of the driver's head, and wherein an image processor is operable to process said captured images to detect at least one of (a) the driver's eyes, (b) dilation of the driver's eyes and (c) movement of the driver's head, and wherein, responsive to said image processing, said alert element is operable to provide said alert when said captured images are indicative of the driver having an alcohol level above said threshold level.
